(19) United States
(12) Patent Application Publication
(10) Pub. No.: US 2010/0067938 A1
(43) Pub. Date: Mar. 18, 2010

(54) IMAGE FORMING APPARATUS WITH RECIPROCALLY MOVABLE CARRIAGE

(75) Inventors: Tsuguyori Kemma, Atsugi-shi (JP); Akiyoshi Tanaka, Fujisawa-shi (JP); Yoichi Ito, Tokyo (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/555,898

(22) Filed: Sep. 9, 2009

(30) Foreign Application Priority Data
Sep. 13, 2008 (JP) 2008-235784

(51) Int. Cl. G03G 21/20

(52) U.S. Cl. 399/91

(57) ABSTRACT

An image forming apparatus includes a reciprocally movable carriage, an image forming unit, a first drive source, a vibration suppressor, and a vibration-suppression controller. The reciprocally movable carriage moves in a main scan direction. The image forming unit is mounted on the carriage. The first drive source moves the carriage. The vibration suppressor suppresses vibration caused by movement of the carriage, and includes a vibration suppression member having a mass smaller than a mass of the carriage and a second drive source independent of the first drive source to move the vibration suppression member. The vibration-suppression controller drives the second drive source to cause the vibration suppressor to perform vibration suppression operation during at least one of an acceleration period and a deceleration period of the carriage, and stops movement of the vibration suppression member during a constant-speed period of the carriage.

### CROSS-REFERENCE TO RELATED APPLICATIONS

The present patent application claims priority pursuant to 35 U.S.C. §119 from Japanese Patent Application No. 2008-235784, filed on Sep. 13, 2008 in the Japan Patent Office, which is incorporated herein by reference in its entirety.

### BACKGROUND OF THE INVENTION

1. Field of the Invention

Illustrative embodiments of the present invention relate to an image forming apparatus, and more particularly, to an image forming apparatus including a reciprocally movable carriage on which an image forming unit is mounted.

2. Description of the Background

Image forming apparatuses are used as printers, facsimile machines, copiers, plotters, or multi-functional peripherals having several of the foregoing capabilities. Known image forming apparatuses employing a liquid-ejection recording method include inkjet recording apparatuses, which eject liquid droplets from a recording head onto a sheet-like recording medium to form a desired image.

Such inkjet-type image forming apparatuses fall into two main types: a serial-type image forming apparatus that forms an image by ejecting droplets while moving a recording head in a main scan direction, and a line-head-type image forming apparatus that forms an image by ejecting droplets from a recording head fixedly disposed in the image forming apparatus.

One conventional serial-type image forming apparatus has a carriage on which a liquid ejection head serving as an image forming unit is mounted. To form a desired image, the apparatus ejects droplets from the liquid ejection head while moving the liquid ejection head in the main scan direction to scan a sheet and intermittingly shifting the sheet in a sub-scanning direction perpendicular to the main scan direction.

However, in the conventional serial-type image forming apparatus, as the carriage moves back and forth, the image forming apparatus vibrates. In particular, when the carriage speed is increased to enhance the print speed, acceleration and deceleration in the main scanning of the carriage are also increased, causing further vibration of the image forming apparatus. Alternatively, in a MFP including an image reading device (also typically known as a scanner), such vibration at the printer side may be transmitted to the scanner during scanning, thereby degrading a resultant scanned image.

In light of the above-described situation, several techniques have been proposed to reduce or suppress vibration of the carriage. In one conventional technique, a vibration suppression member having substantially the same mass as the carriage is attached to a timing belt that moves the carriage and the carriage and the vibration suppression member are moved in opposite directions to suppress the variation of the carriage.

However, in such a configuration in which the variation suppression member (also referred to as a counterweight) is attached to the timing belt that moves the carriage, the counterweight moves (i.e., variation suppression operation is performed) as the carriage moves. Accordingly, for example, slight fluctuation in the carriage speed, slight fluctuation in the movement load of the carriage, or a change in the carriage weight caused by a change in the ink amount remaining in an ink tank may cause the variation suppression member to amplify rather than cancel the vibration of the carriage. For example, when the liquid ejection head is used, such vibration may cause a reduced accuracy of landing positions of liquid droplets, thus resulting in a degraded image quality.

Further, such a configuration may increase the load of a drive source of a main-scan mechanism that moves the carriage, and use of the variation suppression member having substantially the same mass as a mass of the carriage results in an increased overall size and weight of the image forming apparatus.

Hence, in another conventional technique, an image forming apparatus includes a printer head and a weight member having substantially the same mass as a mass of a printer head. Further, the image forming apparatus includes a scan mechanism that moves the printer head and another scan mechanism that moves the weight member in a direction opposite a movement direction of the printer head at an acceleration speed identical to that of the printer head.

However, with such a configuration, since the variation suppression member having substantially the same mass as that of the printer head is moved in a direction opposite the movement direction of the printer head at an acceleration speed identical to that of the printer head, as described above, the variation suppression operation of the variation suppression member may inadvertently degrade image quality, as well as resulting in an increased overall size and weight of the image forming apparatus.

### SUMMARY OF THE INVENTION

The present disclosure provides an image forming apparatus without significant increases in weight and size capable of forming a quality image while suppressing vibration of the image forming apparatus caused by movement of a carriage.

In one illustrative embodiment, an image forming apparatus includes a reciprocally movable carriage, an image forming unit, a first drive source, a vibration suppressor, and a vibration-suppression controller. The reciprocally movable carriage moves in a main scan direction. The image forming unit is mounted on the carriage. The first drive source moves the carriage. The vibration suppressor suppresses vibration caused by movement of the carriage, and includes a vibration suppression member having a mass smaller than a mass of the carriage and a second drive source independent of the first drive source to move the vibration suppression member. The vibration-suppression controller drives the second drive source to cause the vibration suppressor to perform vibration suppression operation during at least one of an acceleration period and a deceleration period of the carriage, and stops movement of the vibration suppression member during a constant-speed period of the carriage.

In another illustrative embodiment, an image forming apparatus includes a reciprocally movable carriage, an image forming unit, a first drive source, a variation suppressor, and a variation-suppression controller. The reciprocally movable carriage moves in a main scan direction. The image forming unit is mounted on the carriage. The first drive source moves the carriage. The variation suppressor suppresses vibration caused by movement of the carriage, and includes a variation suppression member having a mass smaller than a mass of the carriage and a second drive source independent of the first drive source to move the variation suppressor. The variation-suppression controller drives the second drive source to cause the vibration suppressor to perform vibration suppression operation of suppressing the vibration.

In still another illustrative embodiment, an image forming apparatus includes a reciprocally movable carriage, an image forming unit, a first drive source, a variation suppressor, and a variation-suppression controller. The reciprocally movable carriage moves in a main scan direction. The image forming unit is mounted on the carriage. The first drive source moves the carriage. The vibration suppressor suppresses vibration caused by movement of the carriage, and includes a vibration suppression member and a second drive source independent of the first drive source to move the vibration suppression member. The vibration-suppression controller drives the second drive source to cause the vibration suppressor to perform vibration suppression operation during at least one of an acceleration period and a deceleration period of the carriage, and stops movement of the vibration suppression member during a constant-speed period of the carriage.

### BRIEF DESCRIPTION OF THE DRAWINGS

A more complete appreciation of the disclosure and many of the attendant advantages thereof will be readily acquired as the same becomes better understood by reference to the following detailed description when considered in connection with the accompanying drawings, wherein:

FIG. 1 is a perspective view illustrating a basic configuration of an image forming apparatus according to illustrative embodiments of the present disclosure;

FIG. 2 is a plan view illustrating a mechanical section of the image forming apparatus illustrated in FIG. 1;

FIG. 3 is a front view illustrating the mechanical section illustrated in FIG. 1;

FIG. 4 is a side view illustrating a portion of the mechanical section;

FIG. 5 is a schematic view illustrating a first illustrating embodiment;

FIG. 6 is a block diagram illustrating a control unit to control a vibration suppressor;

FIG. 7 is a graph illustrating an example of a speed profile;

FIG. 8 is a flow chart illustrating an example of variation suppression control performed by the control unit illustrated in FIG. 6;

FIG. 9 is a schematic plan view illustrating a second illustrative embodiment;

FIG. 10 is a schematic plan view illustrating a third illustrative embodiment;

FIG. 11 is a schematic plan view illustrating a fourth illustrative embodiment;

FIG. 12 is a schematic plan view illustrating a fifth illustrative embodiment;

FIG. 13 is a schematic plan view illustrating a sixth illustrative embodiment;

FIG. 14 is a schematic plan view illustrating a seventh illustrative embodiment;

FIG. 15 is a schematic plan view illustrating an eighth illustrative embodiment;

FIG. 16 is a schematic plan view illustrating a ninth illustrative embodiment;

FIG. 17 is a schematic plan view illustrating a tenth illustrative embodiment;

FIG. 18 is a block diagram illustrating a control unit to control a vibration suppressor in an eleventh illustrative embodiment;

FIG. 19 is a flow chart illustrating an example of vibration-suppression control performed by the control unit illustrated in FIG. 18;

FIG. 20 is a graph illustrating an example of a target speed and an actual speed of a carriage in a normal or speed-priority mode;

FIG. 21 is a graph illustrating an example of a target speed and an accrual speed of a carriage in a high-speed mode;

FIG. 22 is a graph illustrating an example of areas in which acceleration and deceleration are relatively great during acceleration and deceleration periods of the carriage;

FIG. 23 is a flow chart illustrating an example of vibration-suppression control performed by the control unit illustrated in FIG. 18;

FIG. 24 is a flow chart illustrating an example of vibration-suppression control performed by the control unit illustrated in FIG. 18;

FIG. 25 is a flow chart illustrating an example of vibration-suppression control performed by the control unit illustrated in FIG. 18; and

FIG. 26 is a block diagram illustrating a control unit to control a vibration suppressor in a twelfth illustrative embodiment.

The accompanying drawings are intended to depict illustrative embodiments of the present disclosure and should not be interpreted to limit the scope thereof. The accompanying drawings are not to be considered as drawn to scale unless explicitly noted.

### DETAILED DESCRIPTION OF ILLUSTRATIVE EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

For example, the term “sheet” used herein refers to a medium, a recording medium, a recorded medium, a sheet material, a transfer material, a recording sheet, a paper sheet, or the like. The sheet may also be made of material such as paper, string, fiber, cloth, leather, metal, plastic, glass, timber, and ceramic. Further, the term “image formation” used herein refers to providing, recording, printing, or imaging an image, a letter, a figure, a pattern, or the like onto the sheet. Moreover, the term “liquid” used herein is not limited to recording liquid or ink, and may include anything ejected in the form of a fluid, such as DNA samples, resist, pattern material, washing fluid, storing solution, fixing solution. Hereinafter, such liquid may be simply referred to as “ink”.

Although the illustrative embodiments are described with technical limitations with reference to the attached drawings, such description is not intended to limit the scope of the present invention and all of the components or elements described in the illustrative embodiments of this disclosure are not necessarily indispensable to the present invention.

Below, illustrative embodiments according to the present disclosure are described with reference to attached drawings.

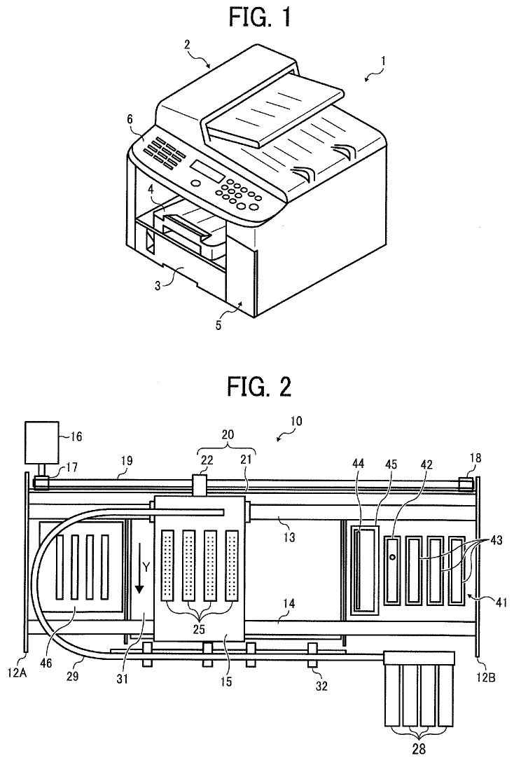

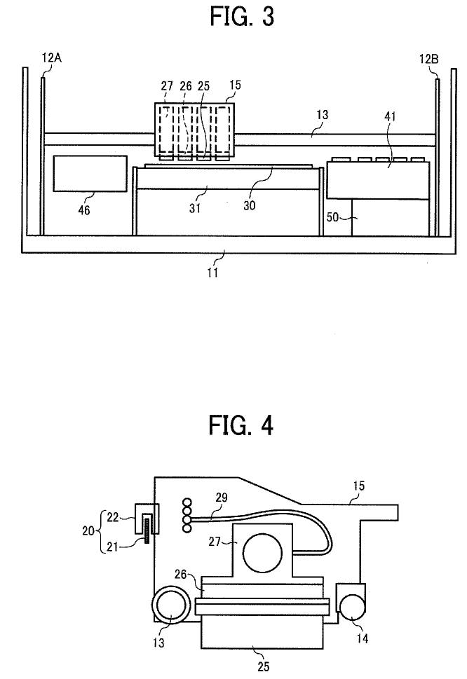

First, a basic configuration of an image forming apparatus 1 according to the following illustrative embodiments is described with reference to FIGS. 1 to 4. FIG. 1 is a perspective view illustrating the image forming apparatus 1. FIG. 2 is a plan view illustrating a mechanical section 10 of the image forming apparatus 1. FIG. 3 is a front view illustrating the mechanical section 10. FIG. 4 is a side view illustrating a portion of the mechanical section 10.

In FIG. 1, at an upper portion of the image forming apparatus 1 is provided an image reading device (scanner) 2 that reads an image. In the image forming apparatus 1 is detachably mounted a sheet feed cassette 3 that stores sheets fed to the mechanical section 10. On the sheet feed cassette 3 is mounted an output tray 4 that stacks a sheet on which an image is formed. At a front side of the image forming apparatus 1 are provided a cartridge install portion 5 to which ink cartridges are installed and a control-and-display unit (control panel) 6 that allows input of various operation signals and displays information.

As illustrated in FIGS. 2 to 4, the mechanical section 10 of the image forming apparatus 1 holds a carriage 15 with a first guide rod 13 serving as a main guide member and a second guide rod 14 serving as a sub-guide member. The first guide rod 13 and the second guide rod 14 are extended between side plates 12A and 12B that stand on a apparatus frame 11. The carriage 15 is held by the first guide rod 13 and the second guide rod 14 so as to slide along a main scan direction (i.e., a long direction of the guide rods 13 and 14).

The carriage 15 is moved for scanning in the main scan direction by a main-scan mechanism including a main-scan motor 16 serving as a first drive source, a driving pulley 17, a driven pulley 18, and a timing belt 19. Along the main scan direction of the carriage 15 is disposed an encoder scale 21. On a back side of the carriage 15 is mounted an encoder sensor 22, such as a transmission-type photosensor, to read a mark (a position identification section) of the encoder scale 21. The encoder scale 21 and the encoder sensor 22 form a linear encoder 20 serving as a carriage position detector.

On the carriage 15 are mounted, for example, four recording heads 25, which are liquid ejection heads serving as an image forming unit that ejects ink droplets of black (K), cyan (C), magenta (M), and yellow (Y) colors, and sub tanks 27 that supply four color inks to the recording heads 25 via filter members 26. Each of the recording heads 25 is mounted on the carriage 15 so that nozzle rows consisting of a plurality of nozzles are arranged along a sub-scan direction perpendicular to the main scan direction and ink droplets are ejected downward from the nozzles.

Respective color inks are supplied through ink tubes 29 from main tanks (ink cartridges) 28 that are detachably mounted in the cartridge install portion 5.

Below the carriage 15 is disposed a conveyance belt 31 serving as a conveyance member to convey a sheet 30, which is fed from the sheet feed cassette 3, in the sub-scan direction. The conveyance belt 31 is, for example, an endless belt extended around a conveyance roller and a tension roller and is circulated in the sub-scan direction indicated by an arrow Y in FIG. 2 as the conveyance roller is rotated by a sub-scan motor. On the downstream side of the conveyance belt 31 are provided output rollers 32 to output the sheet 30 on which an image has been formed.

In a non-image-formation area at one side of the main scan direction of the carriage 15 is disposed a maintenance-and-recovery unit 41 to maintain and recover a preferred optimal operating condition of each recording head 25. The maintenance-and-recovery unit 41 includes, for example, suction caps 42 that suck ink from the recording heads 25 while keeping the nozzle surfaces of the recording heads 25 from drying out, moisture-retention caps 43 that keep the nozzle surfaces of the recording heads 25 from drying out, a wiper blade 44 that wipes the nozzle surfaces, and a first spittoon 45 that receives droplets ejected for maintenance rather than for image formation. Waste ink sucked in the maintenance-and-reccvery operation is drained to a waste-ink tank 50 that is detachably mounted below the main tanks 28 in the cartridge install portion 5.

Further, a second spittoon 46 that receives droplets ejected for maintenance rather than for image formation is provided in a non-image-formation area at the other side in the main scan direction of the carriage 15.

The image forming apparatus 1 also drives the recording heads 25 in response to image signals while moving the carriage 15 in the main scan direction and intermittently conveying the sheet 30, which is fed from the sheet feed cassette 3, using the conveyance belt 131. Thus, the image forming apparatus 1 ejects droplets onto the sheet 30 halted to record one line of a desired image. After conveying the sheet 30 by a certain amount, the image forming apparatus 1 repeats the above-described operation to record another line. When the image formation is finished, the image forming apparatus 1 outputs the sheet 30 on which the desired image has been formed.

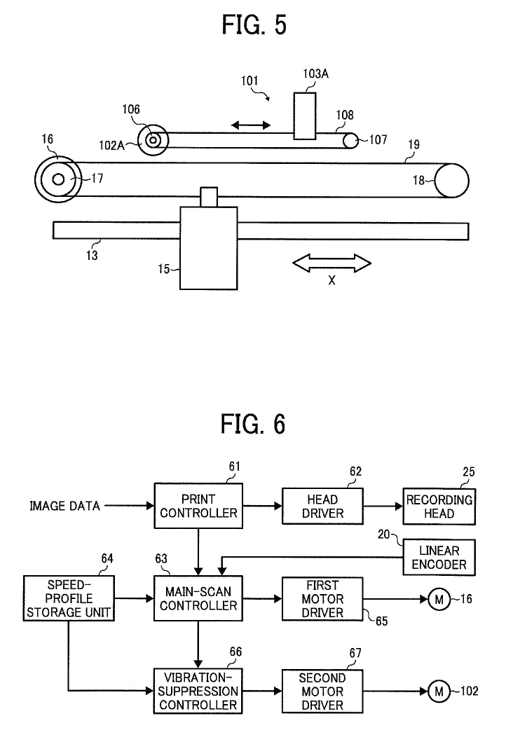

Next, a first illustrative embodiment of the present disclosure is described with reference to FIG. 5. FIG. 5 is a schematic view illustrating a portion of the image forming apparatus 1.

As described above, the carriage 15 is reciprocally moved in the main scan direction (indicated by an open double arrow X) by the main-scan motor 16 via the main scan mechanism including the driving pulley 17, the driven pulley 18, and the timing belt 19.

Hence, for example, on the apparatus frame 11 is disposed a vibration suppressor (vibration suppression mechanism) 101 that suppresses vibration of the image forming apparatus 1 caused by movement of the carriage 15. The vibration suppressor 101 includes a motor 102A, a vibration suppression member (counterweight member) 103A, a driving pulley 106, a driven pulley 107, and a timing belt 108. The motor 102A is a second drive source independent of the main-scan motor 16 that is the drive source of the carriage 15. The motor 102A moves the vibration suppression member 103A attached to the timing belt 108 in the main scan direction. The timing belt 108 is a belt member extended around the driving pulley 106, which is rotated by the motor 102A, and the driven pulley 107 so as to slide in the main scan direction.

In the vibration suppressor 101, by driving the motor 102A serving as a second drive source, the timing belt 108 is moved to move the vibration suppression member 103A in the main scan direction. Stopping the motor 102A during movement of the vibration suppression member 103A causes an inertial force of the vibration suppression member 103A. Causing the inertial force of the vibration suppression member 103A in a direction opposite a direction of an inertial force generated by movement of the carriage 15 allows suppressing vibration of the apparatus frame 11 caused by movement of the carriage 15.

Next, a control unit that controls the vibration suppressor 101 is described with reference to FIG. 6.

As illustrated in FIG. 6, on receiving image data from the image reading device 2 or an external information processing apparatus, such as a personal computer, a print controller 61 controls the recording heads 25 in accordance with the image data via a head driver 62 to eject droplets to form an image on the sheet 30. In accordance with a speed profile, as illustrated in FIG. 6, of the carriage 15 stored in a speed-profile storage unit 64 and an output signal from the linear encoder 20 that detects a position of the carriage 15 in the main scan direction, a main-scan controller 42 calculates a control amount (e.g., a PI control value) using deviation of the current speed from a target speed. The main scan controller 42 also controls the main-scan motor 16 via a first motor driver 65 to move the carriage 15 at a desired carriage speed in the main scan direction.

When the carriage 15 is moved in the main scan direction by the main-scan controller 63, a vibration-suppression controller 66 controls the second drive source (the motor 102A) of the vibration suppressor 101 via a second motor driver 67 in accordance with the speed profile of the carriage 15 stored in the speed-profile storage unit 64 to move or stop the vibration suppression member 103A. Thus, the vibration suppression controller 66 causes the vibration suppressor 101 to perform the vibration suppression operation.

An example of the variation-suppression control performed by the vibration suppression controller 66 is described below with reference to FIG. 8.

When the main scanning (movement) of the carriage 15 is started at S801, at S802 the vibration suppression controller 66 determines whether the movement speed of the carriage 15 is within either an acceleration period or a deceleration period by referring the speed profile stored in the speed-profile storage unit 64. If the speed of the carriage 15 is within either an acceleration period or a deceleration period (“YES” at S802), at S803 the vibration suppression controller 66 controls the vibration suppression member 103A in response to the acceleration or deceleration of the carriage 15 to move at a certain acceleration in a direction to cancel the vibration caused by an inertial force of the movement of the carriage 15. By contrast, if the speed of the carriage 15 is within a constant-speed period (“NO” at S802), at S804 the vibration suppression controller 66 stops the movement of the vibration suppression member 103A.

Thus, the vibration suppression controller 66 moves the vibration suppression member 103A while controlling the motor 102A of the vibration suppressor 101 so as to cancel the vibration caused by the inertial force of movement of the carriage 15. At this time, the vibration suppressor 101 can move the vibration suppression member 103A by the motor 102A, i.e., the second drive source independent of the first drive source (the main-scan motor 16) of the carriage 15. Such a configuration does not require to drive the vibration suppression member 103A by the main-scan motor 16 of the carriage 15, preventing an increased load of the main-scan motor 16. Accordingly, the control of the vibration suppressor 101 can be separated from the control of the carriage 15, allowing finer control of the vibration suppressor 101. Further, an encoder may be mounted on the drive source (the motor 102A) of the vibration suppressor 101, allowing further finer control.

Since the vibration suppression member 103A of the vibration suppressor 101 has a mass smaller than a mass of the carriage 115, increasing the acceleration of the vibration suppression member 103A allows canceling the vibration caused by the inertial force of the carriage 15. Further, reducing the size and weight of the vibration suppression member 103A allows suppressing an increased overall size and weight of the image forming apparatus 1 at a minimum. An impact force F causing such vibration is expressed by an equation, F=m (mass)×a (acceleration), and even when “m” is relatively small, an equivalent impact force F can be obtained by increasing “a”.

The inertial force of the carriage 15, which causes vibration of the apparatus frame 11, is generated in the acceleration and deceleration periods of the movement of the carriage 15. Accordingly, the movement area of the vibration suppression member 103A driven by the second drive source (the motor 102A) independent of the first drive source (the main-scan motor 16) of the carriage 15 is not required to have a width identical to the main scan area of the carriage 15, and may correspond to an area in which the carriage 15 moves in the acceleration and deceleration periods. Such a configuration allows reducing the movement area of the vibration suppression member 103A.

Thus, the vibration suppression member 103A is moved to perform a variation suppression operation in the acceleration and deceleration periods of the carriage 15 and stopped in the constant-speed period. With such a configuration, stopping movement of the vibration suppression member 103A in the constant-speed period during which image formation is performed allows preventing vibration which affects the ejection of droplets from the recording heads 25 and causes, for example, deviation in landing positions of droplets, thus suppressing degradation in image quality.

Thus, the vibration suppressor 101 includes the vibration suppression member 103A having a mass smaller than a mass of the carriage 15 and moved by the second drive source independent of the drive source of the carriage 15. The vibration suppressor 101 also performs variation suppression operation during at least one of the acceleration period and the deceleration period of the carriage 15 and stops movement of the vibration suppression member 103A during the constant-speed period of the carriage 15. Such a configuration can effectively suppress vibration of the image forming apparatus 1 caused by movement of the carriage 15 while preventing degradation in image quality and an increased overall size and weight of the image forming apparatus 1.

In this regard, the variation suppression operation is performed by the vibration suppressor 101 including the vibration suppression member 103A that has a mass smaller than a mass of the carriage 15 and is moved by the second drive source independent of the drive source of the carriage 15. Such a configuration can effectively suppress vibration of the image forming apparatus 1 caused by movement of the carriage 15 while preventing degradation in image quality and an increased overall size and weight of the image forming apparatus 1.

Further, with the vibration suppressor 101 including the vibration suppression member 103A moved by the second drive source independent of the first drive source of the carriage 15, the variation suppression operation is performed during at least one of the acceleration period and the deceleration period of the carriage 15 and movement of the vibration suppression member 103A is stopped during the constant-speed period of the carriage 15. Such a configuration can effectively suppress vibration of the image forming apparatus 1 caused by movement of the carriage 15 while preventing degradation in image quality and an increased overall size and weight of the image forming apparatus 1.

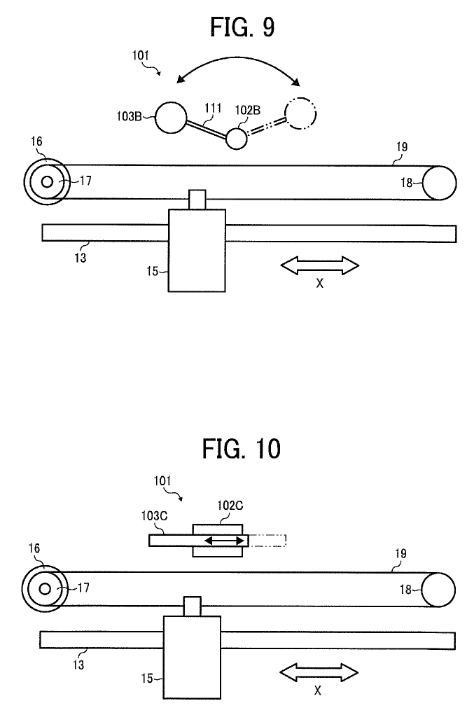

Next, a second illustrative embodiment of the present disclosure is described with reference to FIG. 9. FIG. 9 is a schematic view illustrating the second illustrative embodiment.

In FIG. 9, a vibration suppressor 101 includes a drive source 102B, a vibration suppression member 103B, and an arm 111. The drive source 102B is provided separately from a main-scan motor 16, i.e., a drive source of a carriage 15 and connected to the vibration suppression member 103B via the arm 111. In the vibration suppressor 101, by driving the drive source 102B, the vibration suppression member 103B is swung between a position indicated by a solid line and another position indicated by a chain double-dashed line in FIG. 9.

In such a configuration, when the vibration suppression member 103B is stopped during swinging in directions indicated by a solid double arrow in FIG. 9 along the main scan direction (indicated by an open double arrow X), an inertial force generated by a centrifugal force of the vibration suppression member 103B acts on the drive source 102B. Accordingly, an inertial force of the carriage 15 arising during an acceleration or deceleration period is canceled by the force acting on a fixing member that fixes the drive source 102B to the apparatus frame 11 or another portion of the image forming apparatus 1, thus suppressing vibration of the image forming apparatus 1.

As described above, providing the drive source that swings the vibration suppression member 103B allows a relatively simple configuration of the vibration suppressor 101. Such a configuration allows the inertial force for cancelling the inertial force of the carriage 15 to more directly acting on the image forming apparatus 1 as compared with a configuration in which the vibration suppression member 103B is indirectly moved via a belt member.

Next, a third illustrative embodiment is described with reference to FIG. 10. FIG. 10 is a schematic view illustrating the third illustrative embodiment.

In FIG. 10, a vibration suppressor 101 includes a solenoid 102C serving as a drive source independent of a main-scan motor 16 that is a drive source of a carriage 15, and a vibration suppression member 103C that also serves as a core (plunger) of the solenoid 102C. By driving the solenoid 102C, the vibration suppression member 103C is moved in directions indicated by a solid double arrow in FIG. 10 along the main scan direction (indicated by an open double arrow X).

Thus, forming the drive source with the solenoid 102C whose plunger is the vibration suppression member 103C allows a relatively simple configuration of the vibration suppression member 103C, resulting in a reduced number of components. Such a configuration allows the inertial force for cancelling the inertial force of the carriage 15 to more directly acting on the image forming apparatus 1 as compared with a configuration in which the vibration suppression member 103C is indirectly moved via a belt member.

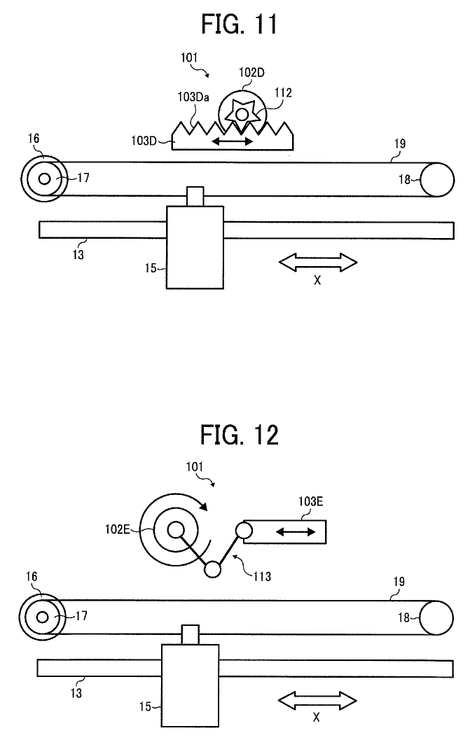

Next, a fourth illustrative embodiment is described with reference to FIG. 11. FIG. 11 is a schematic view illustrating the fourth illustrative embodiment.

In the vibration suppressor 101 illustrated in FIG. 11, a vibration suppression member 103D has a tooth portion (e.g., rack) 103Da formed along the main scan direction (movement directions of a carriage 15), which is indicated by an open double arrow X. The vibration suppression member 103D is moved (in directions indicated by a solid double arrow in FIG. 11) in the main scan direction by a drive source 102D independent of a main-scan motor 16 that is a drive source of a carriage 15 via an engagement member (e.g., pinion) 112 that engages the tooth portion 103Da of the vibration suppression member 103D.

Such a configuration allows a relatively simple configuration of the vibration suppressor 101 with a reduced number of components as compared with, for example, the configuration illustrated in FIG. 5. Such a configuration also allows the inertial force for cancelling the inertial force of the carriage 15 to more directly acting on the image forming apparatus 1 as compared with a configuration in which the vibration suppression member 103D is indirectly moved via a belt member.

Next, a fifth illustrative embodiment is described with reference to FIG. 12. FIG. 12 is a schematic view illustrating the fifth illustrative embodiment.

In a vibration suppressor 101 illustrated in FIG. 12, a vibration suppression member 103E is disposed to move in the main scan direction of the carriage 15 (indicated by an open double arrow X). As a piston link 113 serving as a link mechanism is rotated by a drive source 102E in a direction indicated by a round arrow in FIG. 12, the vibration suppression member 103E is moved (in directions indicated by a solid double arrow) in the main scan direction.

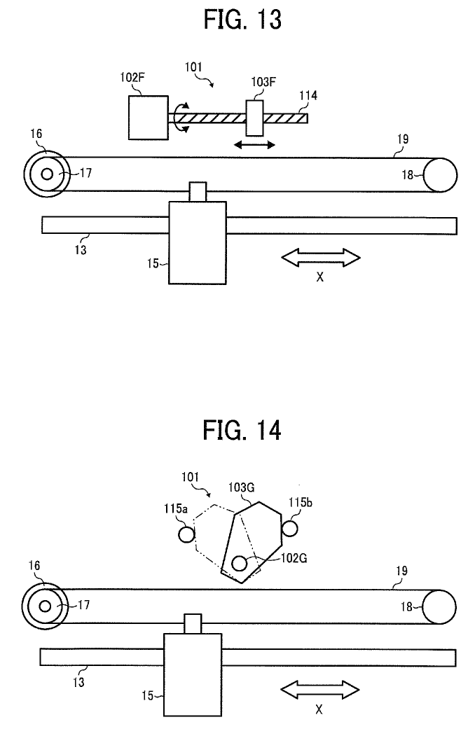

Next, a sixth illustrative embodiment is described with reference to FIG. 13. FIG. 13 is a schematic view illustrating the sixth illustrative embodiment.

In a vibration suppressor 101 illustrated in FIG. 13, a screw 114 rotated by a drive source 102F is disposed along the main scan direction of the carriage 15 (indicated by an open double arrow X). A vibration suppression member 103F is unrotatably engaged with the screw 114, and the vibration suppression member 103F is moved (in directions indicated by a solid double arrow) in the main scan direction by the drive source 102F via the screw 114.

Next, a seventh illustrative embodiment is described with reference to FIG. 14. FIG. 14 is a schematic view illustrating the seventh illustrative embodiment.

In a vibration suppressor 101 illustrated in FIG. 14, a vibration suppression member 103G is pivoted (or rotated) by a drive source 102G, and contact members (e.g., bosses) 115a and 115b are disposed with a gap in the main scan direction. The contact members 115a and 115b may be fixed to, for example, the apparatus frame 11.

In such a configuration, as the vibration suppression member 103G is pivoted (or rotated) by the drive source 102G, the vibration suppression member 103G contacts the contact members 115a and 115b. An inertial force of the carriage 15 is cancelled by an impact force caused by the contact of the vibration suppression member 103G against the contact members 115a and 115b.

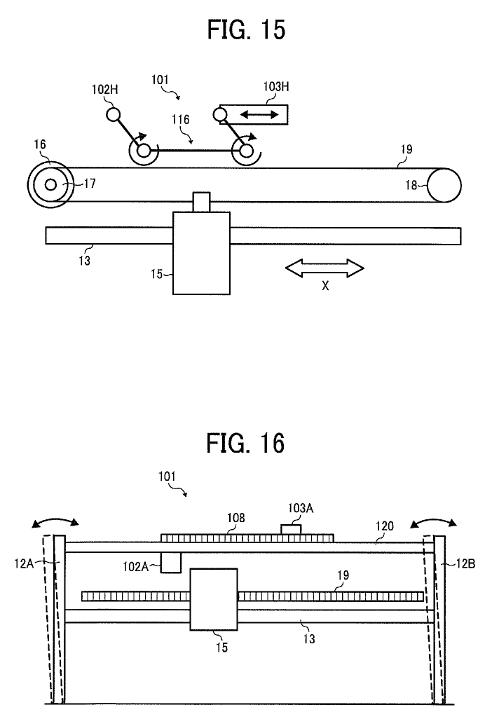

Next, an eighth illustrative embodiment is described with reference to FIG. 15. FIG. 15 is a schematic view illustrating the eighth illustrative embodiment.

In a vibration suppressor 101 illustrated in FIG. 15, a vibration suppression member 103H is disposed to move in the main scan direction of the carriage 15 (indicated by an open double arrow X). As a plurality of nodes of a link mechanism 116 is rotated by a drive source 102H in directions indicated by round arrows in FIG. 15, the vibration suppression member 103H is moved (in directions indicated by a solid double arrow) in the main scan direction.

Thus, linking the drive source 102H and the vibration suppression member 103H via the link mechanism 116 allows the drive source 102H and the vibration suppression member 103H to be disposed with a gap, thus providing an increased layout flexibility.

Next, a ninth illustrative embodiment is described with reference to FIG. 16. FIG. 16 is a schematic view illustrating the ninth illustrative embodiment.

In FIG. 16, as one example, the vibration suppressor 101 illustrated in FIG. 5 is disposed on a base member 120 that is fixed to the side plates 12A and 12B above the carriage 15. That is, the vibration suppressor 101 is disposed above the carriage 15 within the image forming apparatus 1.

At an upper portion of the image forming apparatus 1, a relatively large vibration is caused by an inertial force of the carriage 15 (as indicated by dotted lines and double arrows in FIG. 16). Hence, disposing the vibration suppressor 101 on upper portions of the side plates 12A and 12B allows such vibration to be suppressed with a relatively small force. Further, disposing the vibration suppressor 101 above the carriage 15 obviates the necessity to avoid the location of the sheet conveyance mechanism, thus providing an increased layout flexibility.

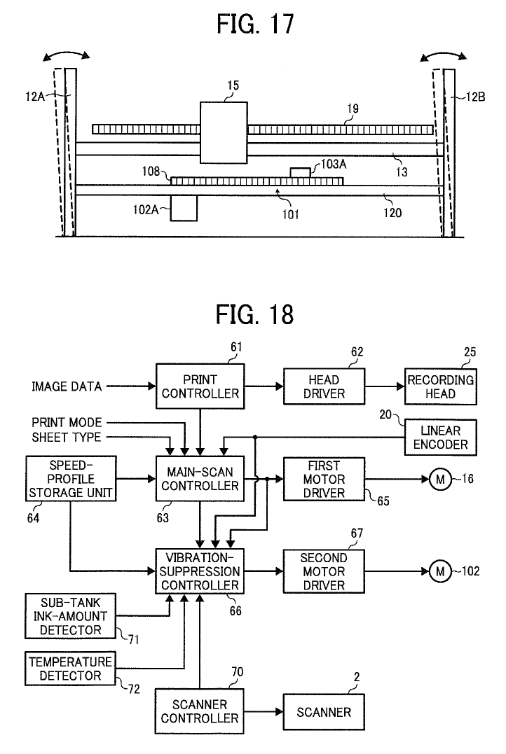

Next, a tenth illustrative embodiment is described with reference to FIG. 17. FIG. 17 is a schematic view illustrating the tenth illustrative embodiment.

In FIG. 17, as one example, the vibration suppressor 101 illustrated in FIG. 5 is disposed on a base member 120 that is fixed to side plates 12A and 12B below the carriage 15.

Since it may be effective to perform variation suppression operation at the center of mass of the image forming apparatus 1, disposing the vibration suppressor 101 at a position taken into account a balance with the center of mass allows suppressing vibration with a relatively small force. It is to be noted that the position of the vibration suppressor 101 is not limited to the position illustrated in FIG. 17 and may be any other suitable position satisfying the above-mentioned conditions.

Next, an eleventh illustrative embodiment is described with reference to FIG. 18. FIG. 18 is a block diagram illustrating components involving variation suppression control in the eleventh illustrative embodiment. Below, the same reference numerals are allocated to components similar to those shown in FIG. 6, and descriptions thereof are omitted for the sake of simplicity.

A main-scan controller 63 selects one speed profile from a plurality of speed profiles, which are stored in a speed-profile storage unit 64, in accordance with information (print-mode information) on a print mode, information (media-type information) on the type of a sheet 30, and other information transmitted from a host machine (e.g., information processing apparatus) or a control panel 6.

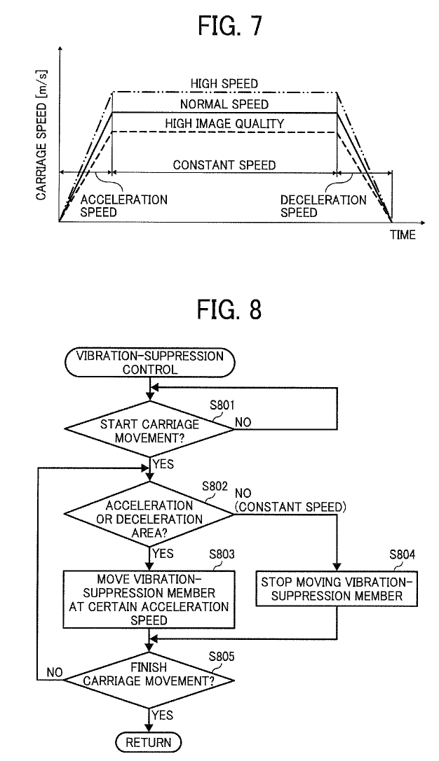

The print mode may be, for example, a normal mode in which an image of a predetermined quality is formed at a predetermined carriage speed, a high-speed (speed-priority) mode in which an image of a relatively low quality is formed at a relatively high speed as compared with the normal mode, or a high-quality mode in which an image of a relatively high quality is formed at a relatively low speed as compared with the normal mode. The media type may be, for example, normal paper, glossy paper, or inkjet print sheet. For example, a speed profile as illustrated in FIG. 7 is stored in the speed-profile storage unit 64, and the main-scan controller 63 controls a main-scan motor 16 in accordance with one speed profile associated with the designated print mode.

A scanner controller 70 controls a scanner (image reading device) 2 to read an image.

A sub-tank ink-amount detector 71 detects an amount of ink remaining in each sub tank 27. For example, by setting an ink amount supplied to one sub tank 27 in an initial ink-refill operation as a default value, the ink amount remaining in the sub tank 27 is obtained from an ink consumption amount calculated by totalizing, for example, the number and amount of droplets ejected from the corresponding recording head 25 and the amount of droplets drained from the corresponding recording head 25 in the maintenance-and-recovery operation of the recording head 25 and an ink refill amount supplied to the sub tank 27 after the initial ink supply.

A temperature detector 72 detects a temperature at the vicinity of the carriage 15 or a temperature in a certain area within the image forming apparatus 1.

Information input to a vibration suppression controller 66 is, for example, information from the main-scan controller 63 on the selected speed profile, information from the scanner controller 70 on whether or not the scanner 2 is in execution of image reading, information from the sub-tank ink-amount detector 71 on the amount of ink remaining in one sub tank 27, information from the temperature detector 72 on a detected temperature, an encoder output from a linear encoder 20, or a motor input value from the main-scan controller 63. The motor input value transmitted from the main-scan controller 63 to a motor driver 65 is, for example, a PWM (pulse width modulation) value (signal) when the main-scan motor 16 is driving by PWM control.

The vibration suppression controller 66 also serves as a mass detector that detects (estimates) an actual mass (weight) of the carriage 15 on the basis of detection results of the sub-tank ink-amount detector 71. In the configuration in which the sub tanks 27 are mounted on the carriage 15, since the actual mass of the carriage 15 varies with ink consumption, an impact force F caused by the carriage 15, which is obtained by multiplying a mass “m” by an acceleration “a”, also varies with ink consumption. Hence, controlling the variation suppression operation of the vibration suppressor 101 in response to the detected actual mass of the carriage 15 allows controlling the variation suppression operation to be controlled in response to the actual acceleration of the carriage 15.

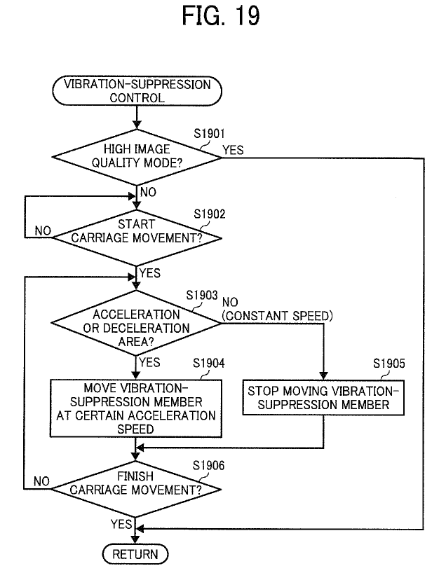

Next, an example of a control procedure of the variation suppression operation by the vibration suppression controller 66 is described with reference to FIG. 19.

At S1901, the vibration suppression controller 66 determines whether a selected speed profile is a high-quality mode.

If the selected speed profile is not the high-quality mode (“NO” at S1901: for example, when it is the normal mode or the high-speed mode in the above-described example), at S1902 the vibration suppression controller 66 determines whether movement of the carriage 15 has been started.

If movement of the carriage 15 has been started (“YES” at S1902), at S1903 the vibration suppression controller 66 determines whether the carriage 15 is within either an acceleration period or an deceleration period.

If the carriage 15 is within either an acceleration period or an deceleration period (“YES” at S1903), at 1904 the vibration suppression controller 66 controls the vibration suppressor 101 to move the vibration suppression member 103, which is a generic designation of the above-described vibration suppression members 103A to 103H, for the variation suppression operation.

By contrast, if the carriage 15 is within a constant-speed period (“NO” at S1903), at 1905 the vibration suppression controller 66 stops movement of the vibration suppression member 103.

Alternatively, if the selected speed profile is the high-quality mode (“YES” at S1901), the vibration suppression controller 66 does not perform the variation suppression operation of the vibration suppressor 101. In other words, the vibration suppression controller 66 keeps the vibration suppression member 103 stopped.

Here, a description is given of one reason why the variation suppression operation is not performed in the high-quality mode.

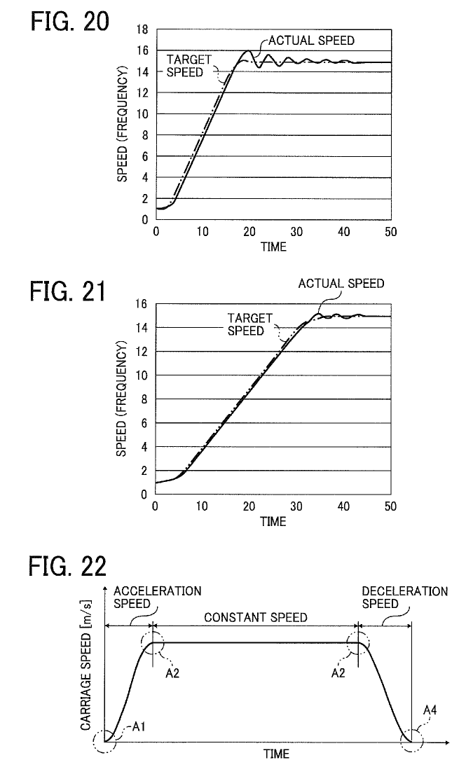

Since printing in the high-quality mode is performed with relatively high precision, even minute vibration of the carriage 15 may affect the resultant image quality. Accordingly, rapid acceleration and deceleration are not performed, thus reducing the necessity of variation suppression operation. Specifically, as illustrated in FIG. 20, if the movement of the carriage 15 is controlled at a target speed, which is indicated by an imaginary line (chain double-dashed line), specified in a speed profile of rapid acceleration (or deceleration), the actual speed of the carriage 15 may vary as indicated by a solid line in FIG. 20. Accordingly, the vibration of the carriage 15 may not be cancelled, degrading image quality. Hence, in the high-quality mode, as illustrated in FIG. 21, the movement of the carriage 15 is controlled in accordance with a speed profile of a relatively low acceleration. With the speed profile that cancels the vibration of the carriage 15 having a relatively small mass as compared with an overall mass of the image forming apparatus 1, the impact against the image forming apparatus 1 is relatively small. As a result, little vibration occurs in the image forming apparatus 1, thus reducing the necessity of variation suppression operation.

By contrast, if the variation suppression operation is performed in the high-quality mode in which printing is performed with high precision, since the vibration of the carriage 15 to be suppressed is relatively small, a slight detection error (e.g., minute fluctuation in the carriage speed and a detection/estimation error of the carriage load, temperature, ink remaining amount, carriage weight, or the like) prevents a variation suppression force from balancing an inertial force of the carriage 15 during acceleration or deceleration. In such a case, the variation suppression operation may cause minute vibration of the carriage 15 rather than cancel the vibration of the carriage 15. Such minute vibration may degrade image quality in the high-quality mode in which printing is performed with relatively high precision. Further, since the variation suppression operation in the high-quality mode may need high-precision control, such as high-precision detection of the weight and speed of the carriage 15 and sophisticated feedback control, thus resulting in relatively-complex mechanism and control of suppressing variation.

Hence, in the present illustrative embodiment, variation suppression operation is not performed in the high-quality mode in which the carriage 15 is moved at a speed at which the vibration caused by acceleration and deceleration of the carriage 15 does not affect the image forming apparatus 1, thus preventing degradation in image quality.

In this case, whether the variation suppression operation is performed is determined in accordance with the print mode. However, it is to be noted that whether the variation suppression operation is performed may be determined in accordance with whether the acceleration (or deceleration) exceeds a predetermined value.

Next, the acceleration and deceleration periods in which the variation suppression operation is performed is described with reference to FIG. 22. FIG. 22 is a graph illustrating a change in carriage speed.

As illustrated in FIGS. 22 and FIG. 7, the carriage speed varies between an acceleration period, a constant-speed period, and a deceleration period. In such a case, the change during acceleration (deceleration) is relatively great in areas indicated by circles in FIG. 22, that is, an area Al at which the carriage starts to move, an area A2 at which the carriage speed shifts from the acceleration period to the constant-speed period, an area A3 at which the carriage speed shifts from the constant-speed period to the deceleration period, and an area A4 at which the carriage stops at the end of the deceleration period. Impact force at the areas A1 to A4 may be a major factor of causing vibration.

Therefore, performing variation suppression operation at the areas A1 to A4 of the change in carriage speed allows effective variation suppression. In other words, instead of performing variation suppression operation across the acceleration and deceleration periods, the variation suppression operation may be performed only at the areas in which the acceleration or deceleration of the carriage exceeds a predetermined value.

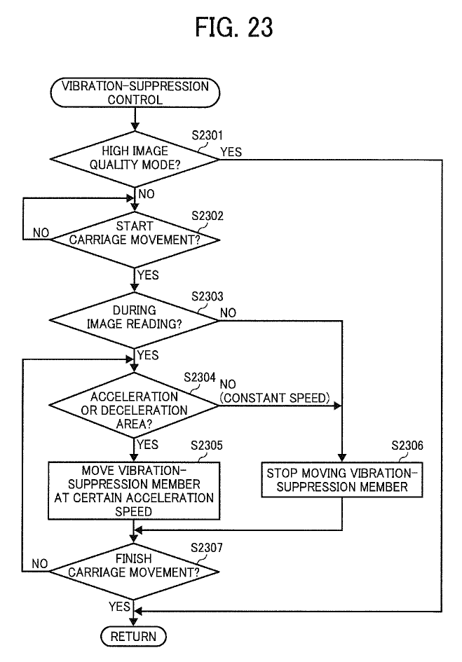

Next, another example of the control of variation suppression operation by the vibration suppression controller 66 is described with reference to FIG. 23.

In FIG. 23, before performing variation suppression operation, at S2303 the vibration suppression controller 66 determines whether the scanner 2 is in execution of image reading in accordance with information on the operation status of the scanner 2 received from the scanner controller 70.

If the vibration suppression controller 66 is in execution of image reading (“YES” at S2303), at S2304 the vibration suppression controller 66 determines whether the carriage speed is within either the acceleration period or the deceleration period.

If the carriage speed is within either the acceleration period or the deceleration period (“YES” at S2304), at S2305 the vibration suppression controller 66 performs the variation suppression operation, that is, controls the vibration suppression member 103 to move at a certain acceleration.

By contrast, if the vibration suppression controller 66 is not in execution of image reading (“NO” at S2303), the vibration suppression controller 66 does not perform variation suppression operation, that is, keeps the vibration suppression member 103 stopped at S2306.

Since the scanner 2 is disposed at an upper portion of the image forming apparatus 1, vibration caused in the image forming apparatus 1 is likely to affect the scanner 2. Consequently, if vibration arises in the image forming apparatus 1 during image reading of the scanner 2, the image reading accuracy of the scanner may be reduced. Hence, in this example, the vibration suppression controller 66 performs variation suppression operation only while the scanner 2 performs image reading.

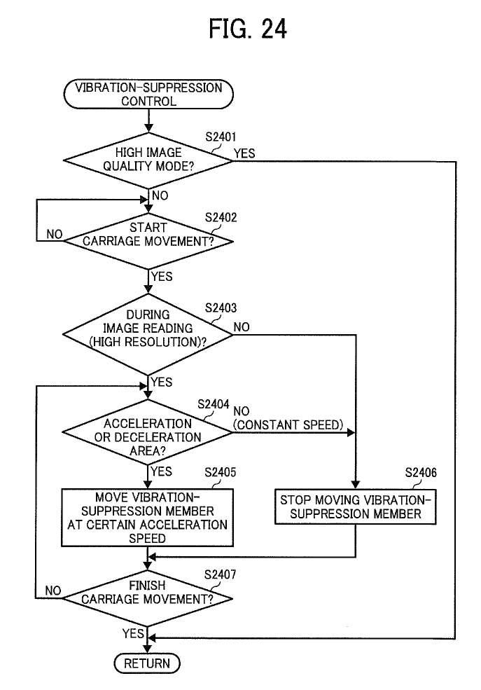

Next, another example of the control of variation suppression operation by the vibration suppression controller 66 is described with reference to FIG. 24.

In FIG. 24, before performing variation suppression operation, at S2403 the vibration suppression controller 66 determines whether the scanner 2 is in execution of high-resolution image reading in accordance with information on the operation status of the scanner 2 received from the scanner controller 70.

If the vibration suppression controller 66 is in execution of high-resolution image reading (“YES” at S2403), at S2404 the vibration suppression controller 66 determines whether the carriage speed is within either an acceleration period or a deceleration period.

If the carriage speed is within either an acceleration period or a deceleration period (“YES” at S2404), at S2405 the vibration suppression controller 66 performs the variation suppression operation, that is, controls the vibration suppression member 103 to move at a certain acceleration speed.

By contrast, if the vibration suppression controller 66 is not in execution of high-resolution image reading (“NO” at S2403), at S2404 the vibration suppression controller 66 does not perform the variation suppression operation, that is, keeps the vibration suppression member 103 stopped at S2406.

As described above, since the scanner 2 is disposed at an upper portion of the image forming apparatus 1, vibration caused in the image forming apparatus 1 is likely to affect the scanner 2. Consequently, if vibration arises in the image forming apparatus 1 during image reading of the scanner 2, the image reading accuracy of the scanner 2 may be reduced. However, when the image reading resolution is not so high, a relatively low level of vibration may not affect resultant image quality. Hence, in this example, the vibration suppression controller 66 performs variation suppression operation only while the scanner 2 performs high-resolution image reading. As a threshold of “high resolution”, for example, a predetermined dot density, such as 400 dpi (dot per inch), may be employed. If the image reading accuracy exceeds the predetermined dot density, the vibration suppression controller 66 performs the variation suppression operation.

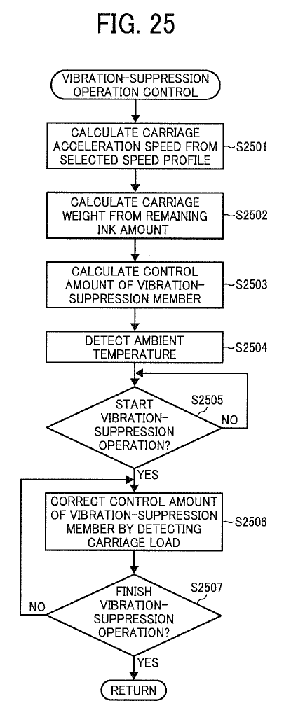

Next, another example of the control of variation suppression operation by the vibration suppression controller 66 is described with reference to FIG. 25.

At S2501, the vibration suppression controller 66 calculates acceleration and deceleration in the acceleration and deceleration periods of the carriage 15 based on a speed profile selected in accordance with the print mode or media type.

At S2502, the vibration suppression controller 66 receives an ink remaining amount detected with the sub-tank ink-amount detector 71 and calculates a weight of the carriage 15 from the ink remaining amount.

At S2503, the vibration suppression controller 66 calculates a control amount of the vibration suppression member 103 (a drive control amount of the drive source 102). The control amount of the vibration suppression member 103 is calculated as an acceleration or deceleration (or a movement amount) of the vibration suppression member 103.

At S2504, the calculated control amount is corrected according to an ambient temperature of the carriage 15 (or a temperature at another point within the image forming apparatus 1) detected by the temperature detector 72. The above-described calculation and correction may include acquiring a value by referring to a lookup table.

Accordingly, since an inertial force (impact force “F”=mass “m”×acceleration “a”) is obtained based on the acceleration of the carriage 15 acquired from the speed profile and the actual mass of the carriage 15 calculated from the ink remaining amount, a corresponding inertial force (or impact force) to be generated with the vibration suppression member 103 is obtained. In this regard, detecting the ambient temperature of the carriage 15 can provide a movement load or viscosity resistant value of the ink tube 29 or another component connected to the carriage 15 or viscosity resistant values of the guide rods 13 and 14 holding the carriage 15. Correcting the control amount of the vibration suppression member 103 with such load or viscosity resistant values allows higher precision of the variation suppression operation.

When the variation suppression operation is started at S2505, at S2506 the movement load of the carriage 15 (and/or the actual acceleration of the carriage 15) is detected based on an encoder pulse received from the encoder 20 (an output value of the main-scan motor 16) and a PWM value received from the main-scan controller 63 (an input value to the main-scan motor). In response to a detection result of the movement load, the vibration suppression controller 66 corrects the control amount and moves the vibration suppression member 103 in accordance with the corrected control amount. Such a configuration allows higher precision of the variation suppression operation. Further, the control amount may be corrected by detecting an operation status of the vibration suppressor 101, allowing controlling the movement of the vibration suppression member 103 with relatively high precision. For example, in the first illustrative embodiment illustrated in FIG. 5, the movement amount and speed of the timing belt 108 are detected with the encoder 20 and corrected so that the vibration suppression member 103 moves at a target acceleration.

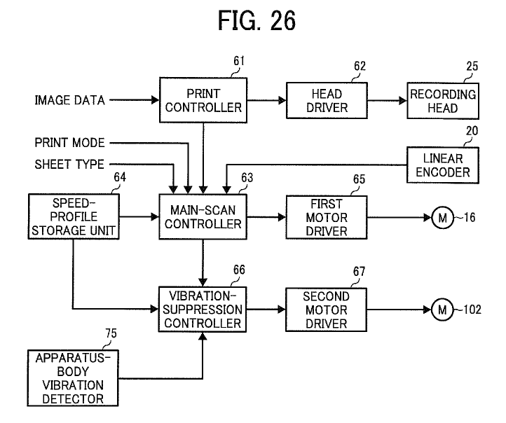

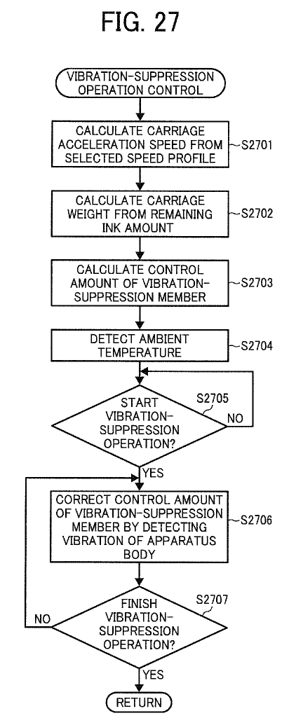

Next, a twelfth illustrative embodiment is described with reference to FIG. 26. FIG. 26 is a block diagram illustrating components involving the control of variation suppression operation in the twelfth illustrative embodiment. Below, the same reference numerals are allocated to components similar to those shown in FIG. 6, and descriptions thereof are omitted for the sake of simplicity.

In FIG. 26, the image forming apparatus 1 includes an apparatus vibration detector 75 to detect vibration of the image forming apparatus 1 and controls variation suppression operation of a vibration suppression member 103 in response to a detected vibration value. In this case, as illustrated in FIG. 27, the variation suppression operation may be controlled in a feedback manner using the detected vibration value and an output value to the vibration suppressor 101.

Further, as with the above-described example, as illustrated in FIG. 27, the vibration suppression controller 66 may detect an ambient temperature of the carriage 15, a movement load of the carriage 15, and a drive state of the control mechanism section to correct the control amount of the vibration suppression member 103, allowing higher precision of variation suppression control.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the scope of the present invention, and all such modifications are intended to be included within the scope of the present invention.

For example, elements and/or features of different illustrative embodiments may be combined with each other and/or substituted for each other within the scope of this disclosure and appended claims.

What is claimed is:

1. An image forming apparatus, comprising:
a reciprocally movable carriage to move in a main scan direction;
an image forming unit mounted on the carriage;
a first drive source to move the carriage;
a vibration suppressor to suppress vibration caused by movement of the carriage, the vibration suppressor comprising:
a vibration suppression member having a mass smaller than a mass of the carriage; and
a second drive source independent of the first drive source to move the vibration suppression member; and
a vibration-suppression controller that drives the second drive source to cause the vibration suppressor to perform vibration suppression operation during at least one of an acceleration period and a deceleration period of the carriage, and stops movement of the vibration suppression member during a constant-speed period of the carriage.

2. The image forming apparatus according to claim 1, wherein the second drive source moves the vibration suppression member in the main scan direction of the carriage via a belt member.

3. The image forming apparatus according to claim 1, wherein the second drive source swings the vibration suppression member in the main scan direction of the carriage.

4. The image forming apparatus according to claim 1, wherein the second drive source is a solenoid having a plunger that moves in the main scan direction of the carriage and the vibration suppression member is also the plunger.

5. The image forming apparatus according to claim 1, wherein the vibration suppression member has a tooth portion disposed in the main scan direction of the carriage, and the second drive source moves the vibration suppression member in the main scan direction of the carriage via an engagement member that engages the tooth portion of the vibration suppression member.

6. The image forming apparatus according to claim 1, further comprising a link mechanism disposed between the second drive source and the vibration suppression member,
wherein the second drive source moves the vibration suppression member in the main scan direction of the carriage via the link mechanism.

7. The image forming apparatus according to claim 6, wherein the link mechanism is a screw.

8. The image forming apparatus according to claim 1, wherein the vibration suppressor is disposed higher than the carriage within the image forming apparatus.

9. The image forming apparatus according to claim 1, wherein the vibration suppression controller causes the variation suppressor to perform the vibration suppression operation in accordance with an acceleration or deceleration of the carriage.

10. The image forming apparatus according to claim 1, wherein the vibration suppression controller causes the variation suppressor to perform the vibration suppression operation when an acceleration or deceleration of the carriage exceeds a predetermined value.

11. The image forming apparatus according to claim 1, wherein the vibration suppression controller causes the variation suppressor to perform the vibration suppression operation in accordance with a type of a recording medium on which an image is formed by the image forming unit.

12. The image forming apparatus according to claim 1, further comprising a mass detector to detect a mass of the carriage,
wherein the variation suppression controller causes the variation suppressor to perform the vibration suppression operation in accordance with the mass of the carriage detected by the mass detector.

13. The image forming apparatus according to claim 1, further comprising a temperature detector to detect a temperature within the image forming apparatus,
wherein the variation suppression controller causes the variation suppressor to perform the vibration suppression operation in accordance with the temperature detected by the temperature detector.

14. The image forming apparatus according to claim 1, further comprising a load detector to detect a movement load of the carriage,
wherein the variation suppression controller causes the variation suppressor to perform the vibration suppression operation in accordance with the movement load of the carriage detected by the load detector.

15. The image forming apparatus according to claim 1, further comprising a vibration detector to detect vibration of the image forming apparatus,
wherein the variation suppression controller causes the variation suppressor to perform the vibration suppression operation in accordance with the vibration of the image forming apparatus detected by the vibration detector.

16. The image forming apparatus according to claim 1, further comprising an image reading device to read an image at an upper portion of the image forming apparatus,
wherein the variation suppression controller controls the vibration suppression operation of the variation suppressor in accordance with an operation status of the image reading device.

17. The image forming apparatus according to claim 16, wherein the variation suppression controller controls the vibration suppression operation of the variation suppressor in accordance with a reading resolution of the image reading device.

18. An image forming apparatus, comprising:
a reciprocally movable carriage to move in a main scan direction;
an image forming unit mounted on the carriage;
a first drive source to move the carriage;
a variation suppressor to suppress vibration caused by movement of the carriage, the variation suppressor comprising:
a variation suppression member having a mass smaller than a mass of the carriage; and
a second drive source independent of the first drive source to move the variation suppressor; and
a variation-suppression controller that drives the second drive source to cause the vibration suppressor to perform vibration suppression operation of suppressing the vibration.

19. An image forming apparatus, comprising:
a reciprocally movable carriage to move in a main scan direction;
an image forming unit mounted on the carriage;
a first drive source to move the carriage;
a vibration suppressor to suppress vibration caused by movement of the carriage, the vibration suppressor comprising a vibration suppression member and a second drive source independent of the first drive source to move the vibration suppression member; and
a vibration-suppression controller that drives the second drive source to cause the vibration suppressor to perform vibration suppression operation during at least one of an acceleration period and a deceleration period of the carriage and stops movement of the vibration suppression member during a constant-speed period of the carriage.
